(19) United States
(12) Patent Application Publication
(10) Pub. No.: US 2012/0274211 A1
(43) Pub. Date: Nov. 1, 2012

(54) LED light bulb

(76) Inventor: De Xiang Xue, Jiashan (CN)

(21) Appl. No.: 13/066,953

(22) Filed: Apr. 27, 2011

(51) Int. Cl. H01J 13/46; H01J 61/52

(52) U.S. Cl. 315/35; 313/46

(57) ABSTRACT

A LED light bulb includes a bulb casing, a control circuit, a light reflective heat sink, a supporting member and a plurality of LEDs. The supporting member is mounted in a receiving cavity of the bulb casing at a position having physical contact with the light reflective heat sink. The LEDs are spacedly provided on the supporting member to form a LED matrix thereon, wherein when the LEDs are activated to generate light, the light generated by the LEDs is arranged to be reflected by the supporting member and the light reflective heat sink to form high intensity illumination of the LED light bulb, while heat generated by the LEDs are effectively transferred and dissipated by the light reflective heat sink through the supporting member so as to prevent overheating in the receiving cavity.

### BACKGROUND OF THE PRESENT INVENTION

1. Field of Invention

The present invention relates to a light bulb, and more particularly to a LED light bulb comprising a plurality of LEDs which are formed in a matrix for providing effective illumination while not having overheat problem.

2. Description of Related Arts

A conventional light bulb usually comprises a base, a transparent main body, a filament implemented in the main body. When the light bulb is electrically connected to an external power source, the filament will generate a predetermined amount of illumination. A well-known disadvantage of this type of light bulb is that the filament may break due to excessively high temperature developed in the transparent main body.

As an attempt to resolve this problem, LED light bulbs have been developed in which the major elements used for generating illumination have become LEDs instead of filaments. The advantage of using LEDs is that the general life span of LED light bulbs is longer than that of traditional filament-type light bulb. Moreover, LEDs light bulbs are more environmentally friendly in that they consume less energy than traditional filament-type light bulbs. The problem for conventional LED light bulbs, however, is that many LEDs must be used in order to generate adequate illumination. Thus, this brings overheating problem again. As a result, there is a tension between adequate illumination and overheating phenomenon for LED-type light bulb.

### SUMMARY OF THE PRESENT INVENTION

The invention is advantageous in that it provides a LED light bulb comprising a plurality of LEDs which are formed in a matrix for providing effective illumination while not having overheat problem.

Another advantage of the invention is to provide a LED light bulb comprising a plurality of LEDs which are formed in a matrix, wherein the matrix of the LEDs are mounted on a supporting member which is in physical contact of a light reflective heat sink.

Another advantage of the invention is to provide a LED light bulb, wherein the light reflective heat sink is used both for dissipating heat generated by the LEDs and reflecting light generated by the LEDs. Thus, the present invention is capable of providing adequate illumination by effectively reflecting light generated by the LEDs while at the same time preventing overheating by timely and effectively dissipating heat generated by the LEDs. In other words, the general life span of the present invention can be maximized.

Another advantage of the invention is to provide a LED light bulb in which the LED matrix formed on the supporting member is safely and conveniently replaceable.

Additional advantages and features of the invention will become apparent from the description which follows, and may be realized by means of the instrumentalities and combinations particular point out in the appended claims.

According to the present invention, the foregoing and other objects and advantages are attained by providing a LED light bulb, comprising:

a bulb casing having a conductive head for electrically connected to a power source, and a light body which defines a receiving cavity and an illumination opening communicating the receiving cavity with an exterior of the bulb casing;

a control circuit mounted in the receiving cavity and electrically connected with the conductive head;

a light reflective heat sink mounted in the receiving cavity;

a supporting member mounted in the receiving cavity at a position having physical contact with the light reflective heat sink; and

a plurality of LEDs spacedly provided on the supporting member to form a LED matrix thereon, wherein when the LEDs are activated to generate light, the light generated by the LEDs is arranged to be reflected by the supporting member and the light reflective heat sink to form high intensity illumination of the LED light bulb, while heat generated by the LEDs are effectively transferred and dissipated by the light reflective heat sink through the supporting member so as to prevent overheating in the receiving cavity.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a LED light bulb according to a preferred embodiment of the present invention.

FIG. 2 is an exploded perspective view of a LED light bulb according to the above preferred embodiment of the present invention.

FIG. 3 is a sectional side view of the LED light bulb according to the above preferred embodiment of the present invention.

FIG. 4 is a schematic diagram of the control circuit of the LED light bulb according to the above preferred embodiment of the present invention.

### DETAILED DESCRIPTION OF THE PREFERRED EMBODIMENT

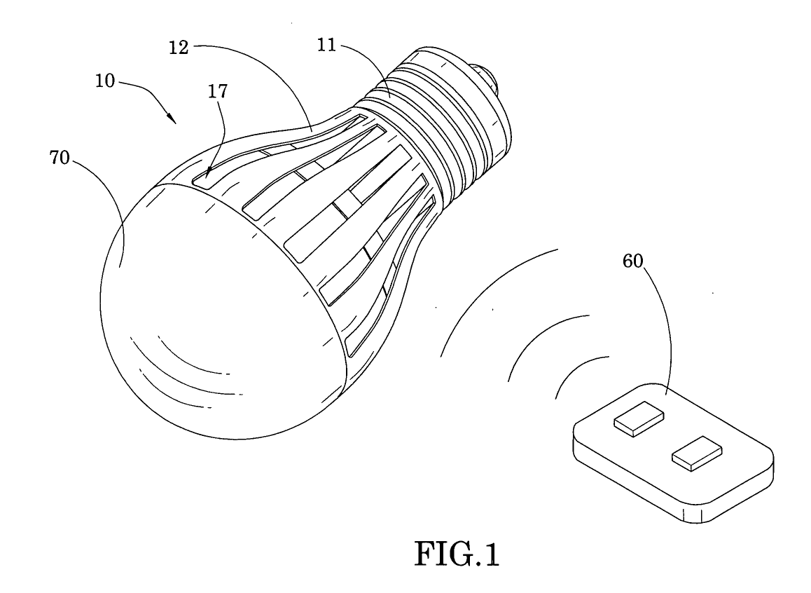

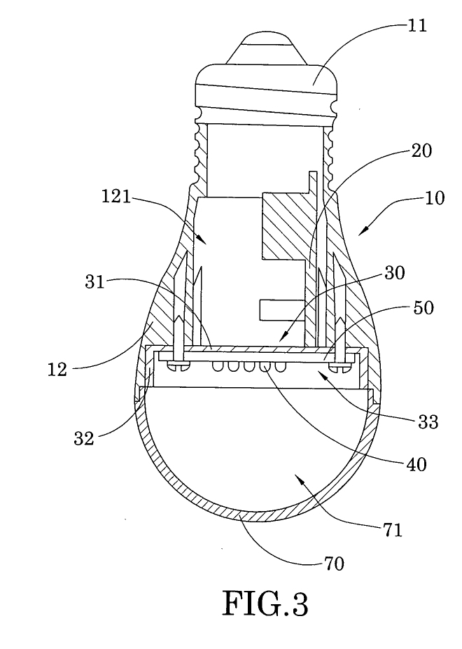

Referring to FIG. 1 to FIG. 3 of the drawings, a LED light bulb according to a preferred embodiment of the present invention is illustrated, in which the LED light bulb comprises a bulb casing 10, a control circuit 20, a light reflective heat sink 30, a plurality of LEDs 40 and a supporting member 50.

The bulb casing 10 has a conductive head 11 for electrically connected to a power source, and a light body 12 which defines a receiving cavity 121 and an illumination opening 122 communicating the receiving cavity 121 with an exterior of the bulb casing 10. The control circuit 20 is mounted in the receiving cavity 121 and electrically connected with the conductive head 11.

The light reflective heat sink 30 is mounted in the receiving cavity 121. The supporting member 50 is mounted in the receiving cavity 121 at a position having physical contact with the light reflective heat sink 30.

The plurality of LEDs 40 is spacedly provided on the supporting member 50 to form a LED matrix thereon, wherein when the LEDs 40 are activated to generate light, the light generated by the LEDs is arranged to be reflected by the supporting member 50 and the light reflective heat sink 30 to form high intensity illumination of the LED light bulb, while the heat generated by the LEDs are effectively transferred and dissipated by the light reflective heat sink 30 through the supporting member 50 so as to prevent overheating in the receiving cavity 121.

According to the preferred embodiment of the present invention, the light body 12 of the bulb casing 10 is made of high molecular plastic material which is durable, heat resistant and easy to manufacture. As shown in FIG. 1 of the drawings, the light body 12 is crafted and designed to have a truncated conical shape in which its diameter is gradually decreasing from the illumination opening 122 toward the conductive head 11. On the other hand, the conductive head 11 is made of metallic material for electrically connecting to an external power source for lighting up the LED light bulb.

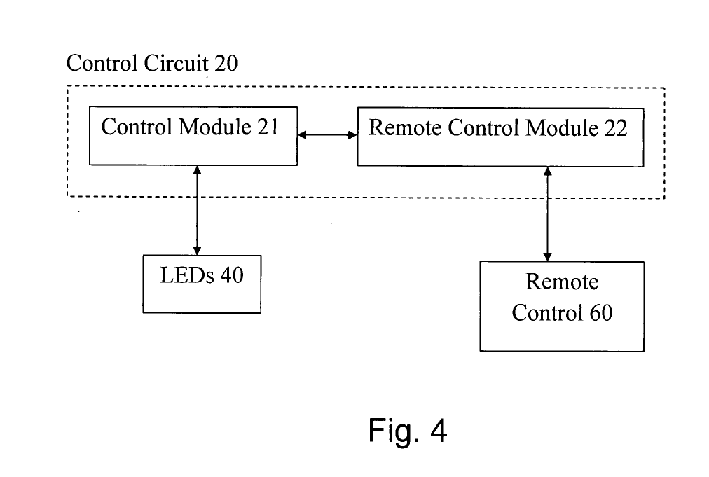

As shown in FIG. 4 of the drawings, the control circuit 20 is securely mounted in the receiving cavity 121 and has an input electrically connected to the conductive head 11 and an output electrically connected to the supporting member 50 so as to provide actuation signal and power to operate the LEDs 40. The control circuit 20 is arranged to perform electrical control to the operation of the LEDs 40 so as to accomplish different operation mode. For example, the control circuit 20 may, through electrical signal delivered to the supporting member 50, controls the intensity of the light generated by the LEDs 40. Thus, the LED light bulb further comprises a remote switch 60 wirelessly connected to the control circuit 20 in such a manner that a user is able to remotely control the operation of the LEDs 40 by simply operating on the remote switch 60. Thus, the control circuitry 20 has a control module 21 for controlling the operation of LEDs 40, and a remote control module 22 for wirelessly communicating with the remote switch 60 and to transmit the wireless signal to the control module 21 so as to execute the corresponding wireless signal.

The light reflective heat sink 30 is securely mounted in the receiving cavity 121 and has a circular cross section. More specifically, the light reflective heat sink 30 comprises a circular base member 31 and a sidewall 32 peripherally extended from the base member to define a reflection cavity 33 between the base member 31 and the sidewall 32, wherein the supporting member 50 and the LEDs 40 are securely but detachably mounted in the reflection cavity 33 and in physical contact with the base member 31 of the light reflective heat sink 30. The light reflective heat sink 30 is made of metallic material for rapidly dissipating the heat generated by the LEDs 40 as transferred from the supporting member 50. Furthermore, the base member 31 is preferably made of shiny material or has a light reflective surface facing the supporting member 50 so that the light generated by the LEDs 40 are arranged to be reflected in the reflection cavity 33 so as to enhance the quality or the light intensity of the light delivered by the LED light bulb of the present invention.

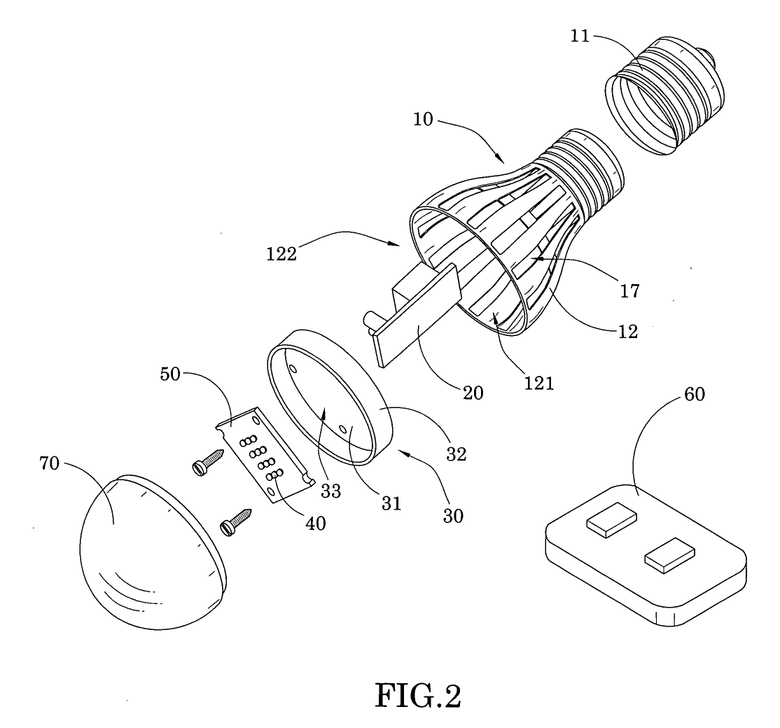

On the other hand, the supporting member 50 is also made of metallic material for securely supporting the LEDs 40 thereon. The LEDs are spacedly provided on the supporting member 50 to form a plurality of rows and columns and thereby forming a LED matrix as shown in FIG. 2 of the drawings. The LED matrix helps to produce a single source of light from the LED light bulb with sufficient light intensity. It is worth mentioning that the supporting member 50 is replaceably mounted on the light reflective heat sink 30 so that when one or more of the LEDs are out of order, a user may detach the supporting member 50 and the LEDs 40 and replace it with a new supporting member 50 and LEDs 40. Thus, the LEDs 40 and the supporting member 50 form a replaceable LED module which can be easily and conveniently replaced.

The LED light bulb further comprises a light cover 70 detachably mounted on the illumination opening 122 of the light body 12, wherein the light cover 70 has a predetermined light transmissivity for allowing the light generated by the LEDs 40 and reflected within the reflection cavity 33 to reach an exterior of the LED light bulb. In this preferred embodiment, the light cover 70 is semi-spherical in structure and defines a light passage cavity 71 communicating with the receiving cavity 121 of the light body 12.

The structure as mentioned above allows heat generated by the LEDs 40 to be rapidly transferred to the supporting member 50 and dissipated through the light reflective heat sink 30. As such, the heat will be transferred very rapidly and minimize the chance of overheating of the LEDs 40. When one or more of the LEDs 40 are out of order, the user can conveniently replace the supporting member 50 with another LED module. This is not true for conventional LED light bulbs.

Furthermore, the bulb casing 10 further has a plurality of elongated auxiliary slots 17 spacedly formed on the light body 12 for facilitating enhanced heat dissipation of the light body 12. The auxiliary slot 17 allows sufficient ventilation between the receiving cavity 121 and an exterior thereof. Moreover, the auxiliary slots 17 also impart aesthetic appearance to the light bulb of the present invention.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A LED light bulb, comprising:
a bulb casing having a conductive head for electrically connected to a power source, and a light body which defines a receiving cavity and an illumination opening communicating said receiving cavity with an exterior of said bulb casing;
a control circuit mounted in said receiving cavity and electrically connected with said conductive head;
a light reflective heat sink mounted in said receiving cavity;
a supporting member mounted in said receiving cavity at a position having physical contact with said light reflective heat sink; and
a plurality of LEDs spacedly provided on said supporting member to form a LED matrix thereon, wherein when said LEDs are activated to generate light, said light generated by said LEDs is arranged to be reflected by said supporting member and said light reflective heat sink to form high intensity illumination of said LED light bulb, while heat generated by said LEDs are effectively transferred and dissipated by said light reflective heat sink through said supporting member so as to prevent overheating in said receiving cavity.

2. The LED light bulb, as recited in claim 1, wherein said light reflective heat sink is securely mounted in said receiving cavity and comprises a circular base member and a sidewall peripherally extended from said base member to define a reflection cavity between said base member and said sidewall, wherein said supporting member and said LEDs are securely and detachably mounted in said reflection cavity and in physical contact with said base member of said light reflective heat sink.

3. The LED light bulb, as recited in claim 2, wherein said heat reflection heat sink further has a light reflective surface facing said supporting member so that said light generated by said LEDs are arranged to be reflected in said reflection cavity so as to enhance a quality of said light delivered by said LED light bulb.

4. The LED light bulb, as recited in claim 2, further comprising a light cover detachably mounted on said illumination opening of said light body, wherein said light cover has a predetermined light transmissivity and a light passage cavity communicating with said receiving cavity for allowing said light generated by said LEDs to pass through said light cover and be reflected within said reflection cavity.

5. The LED light bulb, as recited in claim 3, further comprising a light cover detachably mounted on said illumination opening of said light body, wherein said light cover has a predetermined light transmissivity and a light passage cavity communicating with said receiving cavity for allowing said light generated by said LEDs to pass through said light cover and be reflected within said reflection cavity.

6. The LED light bulb, as recited in claim 4, wherein said control circuit is securely mounted in said receiving cavity and has an input electrically connected to said conductive head and an output electrically connected to said supporting member so as to provide actuation signal and power to operate said LEDs.

7. The LED light bulb, as recited in claim 5, wherein said control circuit is securely mounted in said receiving cavity and has an input electrically connected to said conductive head and an output electrically connected to said supporting member so as to provide actuation signal and power to operate said LEDs.

8. The LED light bulb, as recited in claim 5, further comprising a remote switch wirelessly connected to said control circuit in such a manner that a user is able to remotely control said operation of said LEDs by operating said remote switch, wherein said control circuitry has a control module for controlling said operation of said LEDs, and a remote control module for wirelessly communicating with said remote switch and to transmit said wireless signal to said control module so as to execute said corresponding wireless signal.

9. The LED light bulb, as recited in claim 6, further comprising a remote switch wirelessly connected to said control circuit in such a manner that a user is able to remotely control said operation of said LEDs by operating said remote switch, wherein said control circuitry has a control module for controlling said operation of said LEDs, and a remote control module for wirelessly communicating with said remote switch and to transmit said wireless signal to said control module so as to execute said corresponding wireless signal.

10. The LED light bulb, as recited in claim 7, further comprising a remote switch wirelessly connected to said control circuit in such a manner that a user is able to remotely control said operation of said LEDs by operating said remote switch, wherein said control circuitry has a control module for controlling said operation of said LEDs, and a remote control module for wirelessly communicating with said remote switch and to transmit said wireless signal to said control module so as to execute said corresponding wireless signal.

11. The LED light bulb, as recited in claim 7, wherein said supporting member is made of metallic material, wherein said LEDs are spacedly provided on said supporting member to form a plurality of rows and columns of said LEDs so as to form said LED matrix, wherein said supporting member is replaceably mounted on said light reflective heat sink so that when one or more of said LEDs are out of order, said supporting member and said LEDs are conveniently replaceable.

12. The LED light bulb, as recited in claim 10, wherein said supporting member is made of metallic material, wherein said LEDs are spacedly provided on said supporting member to form a plurality of rows and columns of said LEDs so as to form said LED matrix, wherein said supporting member is replaceably mounted on said light reflective heat sink so that when one or more of said LEDs are out of order, said supporting member and said LEDs are conveniently replaceable.

13. The LED light bulb, as recited in claim 10, wherein said light body is crafted and designed to have a truncated conical shape in which its diameter is gradually decreasing from said illumination opening toward said conductive head, wherein said conductive head is made of metallic material for electrically connecting to an external power source.

14. The LED light bulb, as recited in claim 12, wherein said light body is crafted and designed to have a truncated conical shape in which its diameter is gradually decreasing from said illumination opening toward said conductive head, wherein said conductive head is made of metallic material for electrically connecting to an external power source.

15. The LED light bulb, as recited in claim 10, wherein said bulb casing has a plurality of auxiliary slots spacedly formed thereon for facilitating enhanced heat dissipation of said bulb casing.

16. The LED light bulb, as recited in claim 12, wherein said bulb casing has a plurality of auxiliary slots spacedly formed thereon for facilitating enhanced heat dissipation of said bulb casing.

17. The LED light bulb, as recited in claim 14, wherein said bulb casing has a plurality of auxiliary slots spacedly formed thereon for facilitating enhanced heat dissipation of said bulb casing.

18. The LED light bulb, as recited in claim 12, wherein said light body of said bulb casing is made of high molecular plastic material which is durable, heat resistant and easy to manufacture.

19. The LED light bulb, as recited in claim 14, wherein said light body of said bulb casing is made of high molecular plastic material which is durable, heat resistant and easy to manufacture.

20. The LED light bulb, as recited in claim 17, wherein said light body of said bulb casing is made of high molecular plastic material which is durable, heat resistant and easy to manufacture.
